(19) United States
(12) Patent Application Publication
(10) Pub. No.: US 2023/0337167 A1
(43) Pub. Date: Oct. 19, 2023

(54) CLIENT DEVICE AND NETWORK NODE FOR EFFICIENT DISASTER HANDLING

(71) Applicant: HUAWEI TECHNOLOGIES CO., LTD., Shenzhen (CN)

(72) Inventors: Vishnu PREMAN, Lund (SE); Rama Kumar MOPIDEVI, Lund (SE); Gong CHEN, Shanghai (CN); Xibo SUN, Shanghai (CN); Jianhai CUI, Shenzhen (CN); Linping YANG, Shanghai (CN)

(21) Appl. No.: 18/337,908

(22) Filed: Jun. 20, 2023

Related U.S. Application Data
(63) Continuation of application No. PCT/CN2021/072305, filed on Jan. 15, 2021.

(51) Int. Cl. H04W 60/00; H04W 24/04; H04W 8/06

(52) U.S. Cl. CPC H04W 60/00; H04W 24/04; H04W 8/06; H04W 84/042

(57) ABSTRACT

A client device for efficient disaster handling based on a novel list of PLMNs for disaster conditions. The client device is provided with a list of PLMNs that is used by the client device in response to the serving PLMN of the client device going into a disaster condition. Upon determining that the serving PLMN is in a disaster condition, the client device registers at a visiting PLMN in the PLMN list. The novel list of PLMNs for disaster conditions enables the client device to roam into PLMNs which is forbidden during normal conditions.

### CROSS-REFERENCE TO RELATED APPLICATIONS

This application is a continuation of International Application No. PCT/CN2021/072305, filed on Jan. 15, 2021, the disclosure of which is hereby incorporated by reference in its entirety.

### BACKGROUND

During a disaster cellular networks often gets overloaded and users are therefore denied services. Disasters is manmade such as e.g. a fire in a building or natural such as e.g. an earth quake. In response to a disaster happening, a lot of people try to call emergency services or each other. Due to multiple users requesting services at the same time, the network resources get congested and users are not able to get the requested services.

### SUMMARY

An objective of embodiments described herein is to provide a solution which mitigates or solves the drawbacks and problems of conventional solutions.

The above and further objectives are solved by the subject matter of the independent claims. Further advantageous embodiments described herein are found in the dependent claims.

According to a first aspect of at least one embodiment, the above mentioned and other objectives are achieved with a client device for a communication system, the client device being configured to be served by a serving Public Land Mobile Network, PLMN, and further being configured to
obtain a PLMN list including one or more visiting PLMNs; and
register at a visiting PLMN in the PLMN list upon determining that the serving PLMN is in a disaster condition.

A serving PLMN is understood to be the PLMN currently serving the client device, i.e. providing communication services to the client device. The serving PLMN is the home PLMN, which is typically the case in response to the client device being in its home country. The serving PLMN is further a PLMN different from the home PLMN, e.g. in response to the client device roaming in a different country.

A visiting PLMN is understood to be a PLMN which the client device attempts to register with in a disaster condition. A visiting PLMN is further a PLMN which the client device is not allowed to register with in a normal condition such as a forbidden PLMN, e.g. a PLMN configured in a list of forbidden PLMNs in the client device 100. Each visiting PLMN is indicated by an identity and is further associated with a timer defining a minimum wait time before registration.

A disaster condition is understood to be a condition that a government decides a time to initiate and terminate and is initiated based on a manmade or a natural disaster. In response to the disaster condition applying, users have the opportunity to mitigate service interruptions and failures.

An advantage of the client device according to the first aspect is that the client device has information about the PLMN that is used while in a disaster condition even before the disaster condition has happened. In case of a disaster which affects the serving PLMN, the client device hence knows which PLMN to use and is able to quickly attempt to register with this PLMN. Thereby, minimizing service interruption in response to a disaster condition occurring.

In an implementation form of a client device according to the first aspect, obtaining the PLMN list includes
receiving a first control message from a network node, wherein the first control message indicates the PLMN list.

An advantage with this implementation form is that the network node provides the client device with information about the PLMNs to be used in disaster condition even before the disaster has happened. The network node thereby controls the behaviour of its client devices for a future disaster condition.

In an implementation form of a client device according to the first aspect, the first control message is part of a Non-Access Stratum, NAS, protocol.

An advantage with this implementation form is that a standard protocol already used for communication between the network node and the client device is used, which simplifies the implementation.

In an implementation form of a client device according to the first aspect, the first control message is any of: a configuration update command message, a registration accept message, a registration reject message, a service accept message, a service reject message, and a deregistration request message.

An advantage with this implementation form is that standard messages already used for communication between the network node and the client device is used, which simplifies the implementation. Furthermore, the PLMN list is dynamically changed via any of these messages.

In an implementation form of a client device according to the first aspect, obtaining the PLMN list includes
obtaining the PLMN list from a Subscriber Identity Module, SIM, configuration of the client device.

An advantage with this implementation form is that the PLMN list is pre-configured in the SIM of the client device. Thus, the PLMN list does not have to be signalled to the client device and radio resources is saved.

In an implementation form of a client device according to the first aspect, obtaining the PLMN list includes obtaining the PLMN list from a Mobile Equipment, ME, configuration of the client device.

An advantage with this implementation form is that the PLMN list is pre-configured in the client device. Thus, the PLMN list does not have to be signalled to the client device and radio resources is saved.

In an implementation form of a client device according to the first aspect, the PLMN list includes an identity of each visiting PLMN in the PLMN list.

An advantage with this implementation form is that it provides an easy way for the client device to identify the PLMN.

In an implementation form of a client device according to the first aspect, the PLMN list includes one or more timers, wherein each timer is associated with a visiting PLMN in the PLMN list and defines a start register time instance at the visiting PLMN and/or a re-registration time instance at the serving PLMN.

The timer defining a start register time instance is also understood as a timer defining a minimum wait time to start registration. The timer defining a re-registration time instance is also understood as a timer defining a minimum wait time to start re-registration. A minimum wait time is understood to be the minimum time the client device waits before the client device attempts to register or re-register.

An advantage with this implementation form is that the PLMN list also includes timer information indicating in response to the client device attempting to register with a visiting PLMN in the PLMN list. With the timer information the registration attempts of client devices are controlled such that they do not all attempt to register to a PLMN at the same time. Thereby, preventing overload in that PLMN.

In an implementation form of a client device according to the first aspect, the client device is further configured to
start a timer associated with a visiting PLMN upon camping at the visiting PLMN; and
register at the visiting PLMN in response to the timer associated with the visiting PLMN expiring.

In response to the timer expiring is herein understood to mean upon expiry of the timer or after the timer has expired.

An advantage with this implementation form is that time of the registration of the client device is controlled with the PLMN list. The PLMN list is thereby used to distribute the registration attempts of client devices to a specific PLMN over time, thereby preventing overloading the PLMN during a disaster condition.

In an implementation form of a client device according to the first aspect, the one or more visiting PLMNs in the PLMN list are arranged in a registration priority order for the client device.

This is understood as that the client device should in some case follow the order of the visiting PLMNs in the PLMN list in response to trying to register at a visiting PLMN in the PLMN list.

An advantage with this implementation form is that the PLMN list clearly indicate to the client device which PLMN to attempt to register with in response to the disaster happening. The PLMN list is thereby used to distribute client devices to different visiting PLMNs.

In an implementation form of a client device according to the first aspect, determining that the serving PLMN is in the disaster condition includes
receive a second control message from a network node, wherein the second control message indicates that the serving PLMN is in the disaster condition.

An advantage with this implementation form is that the client device will know a time to start searching for other PLMNs due to the indication about the disaster condition.

In an implementation form of a client device according to the first aspect, the client device is further configured to
provide an output to a user of the client device, wherein the output indicates that the one or more visiting PLMNs in the PLMN list is selected for roaming in response to the serving PLMN being in the disaster condition.

An advantage with this implementation form is that the user is presented with information which allows the user to select an appropriate PLMN in response to a disaster happening.

In an implementation form of a client device according to the first aspect, register at the visiting PLMN in the PLMN list includes
transmit a registration request message to the visiting PLMN, wherein the registration request message indicates a registration request for the client device in response to a previously serving PLMN for the client device being in the disaster condition.

An advantage with this implementation form is that the visiting PLMN knows that the client device is attempting registration on this PLMN as it had to move from another PLMN due to disaster condition. This helps the visiting PLMN to e.g. apply less strict authentication to the client device considering that it is seeking only temporary service from the PLMN.

According to a second aspect of at least one embodiment, the above mentioned and other objectives are achieved with a network node for a wireless communication system, the network node being configured to transmit a control message to a client device, wherein the control message indicates a PLMN list including one or more visiting PLMNs for registration by the client device in response to a serving PLMN for the client device being in a disaster condition.

The network node is associated with the serving PLMN for the client device which is understood to mean that the network node is a part of the serving PLMN.

An advantage of the network node according to the second aspect is that the network node provides the client device with information about the PLMNs to be used in a disaster condition even before the disaster has happened. The network node thereby controls the behaviour of its client devices for a future disaster condition.

In an implementation form of a network node according to the second aspect, the network node is an Access and Mobility management Function, AMF, of a core network.

An advantage with this implementation form is that the AMF provides the client device with information about the PLMNs to be used in a disaster condition even before the disaster has happened. The AMF thereby controls the behaviour of its client devices for a future disaster condition.

In an implementation form of a network node according to the second aspect, the control message is part of a NAS protocol.

An advantage with this implementation form is that a standard protocol already used for communication between the network node and the client device is used, which simplifies the implementation.

In an implementation form of a network node according to the second aspect, the control message is any of: a configuration update command message, a registration accept message, a registration reject message, a service accept message, a service reject message, and a deregistration request message.

An advantage with this implementation form is that standard messages already used for communication between the network node and the client device is used, which simplifies the implementation. Furthermore, the PLMN list is dynamically changed via any of these messages.

According to a third aspect of at least one embodiment, the above mentioned and other objectives are achieved with a method for a client device being configured to be served by a serving PLMN, the method includes
obtaining a PLMN list includes one or more visiting PLMNs; and
registering at a visiting PLMN in the PLMN list upon determining that the serving PLMN is in a disaster condition.

The method according to the third aspect is extended into implementation forms corresponding to the implementation forms of the client device according to the first aspect.

Hence, an implementation form of the method includes the feature(s) of the corresponding implementation form of the client device.

The advantages of the methods according to the third aspect are the same as those for the corresponding implementation forms of the client device according to the first aspect.

According to a fourth aspect of at least one embodiment, the above mentioned and other objectives are achieved with a method for a network node, the method includes transmitting a control message to a client device, wherein the control message indicates a PLMN list including one or more visiting PLMNs for registration by the client device in response to a serving PLMN for the client device being in a disaster condition.

The method according to the fourth aspect is extended into implementation forms corresponding to the implementation forms of the network node according to the second aspect. Hence, an implementation form of the method includes the feature(s) of the corresponding implementation form of the network node.

The advantages of the methods according to the fourth aspect are the same as those for the corresponding implementation forms of the network node according to the second aspect.

At least one embodiment also relates to a computer program, characterized in program code, which in response to being run by at least one processor causes said at least one processor to execute any method according to embodiments described herein. Further, at least one embodiment also relates to a computer program product including a computer readable medium and said mentioned computer program, wherein said computer program is included in the computer readable medium, and includes of one or more from the group: ROM (Read-Only Memory), PROM (Programmable ROM), EPROM (Erasable PROM), Flash memory, EEPROM (Electrically EPROM) and hard disk drive.

Further applications and advantages of the embodiments described herein are apparent from the following detailed description.

### BRIEF DESCRIPTION OF THE DRAWINGS

The appended drawings are intended to clarify and explain different embodiments described herein, in which:

FIG. 1 shows a client device according to at least one embodiment;

FIG. 2 shows a method for a client device according to at least one embodiment;

FIG. 3 shows a network node according to at least one embodiment;

FIG. 4 shows a method for a network node according to at least one embodiment;

FIG. 5 shows a communication system according to at least one embodiment;

FIG. 6 shows a flow chart of a method for a client device according to at least one embodiment; and

FIG. 7 shows signalling from a network node according to at least one embodiment.

### DETAILED DESCRIPTION

In response to a public land mobile network (PLMN) not being able to provide services such as e.g. voice calls or mobile data services to a user equipment (UE) due to a disaster condition, there are often other PLMNs available in the area which is able to provide service to the UE. However, those PLMNs could be configured to be forbidden PLMNs in the UE and the UE will hence never select one of those PLMNs.

To minimization service interruptions, it would be beneficial to enable a UE of a given PLMN to obtain service from another PLMN for an area where a disaster condition applies, even in response to the other PLMN being a forbidden PLMN for the UE under normal conditions. PLMN selection is a procedure in the UE which enables the UE to select the most appropriate PLMN at a particular point of time. Most of the time in response to the UE being in the home country, the home PLMN will be the most appropriate PLMN and the home PLMN will thus be the serving PLMN. To prevent the UE from switching from the home PLMN, roaming is often disabled inside the home country. Other PLMNs in the home country are e.g. be added to a list of forbidden PLMNs so that the UE does not roam unnecessarily into these PLMNs.

At least one embodiment provides an improved PLMN selection for a UE during disaster conditions. The UE is provided with a list of PLMNs that is used by the UE in response to the serving PLMN of the UE being in a disaster condition. With the list of PLMNs for the disaster condition, the UE is allowed to roam into even forbidden PLMNs during a disaster condition.

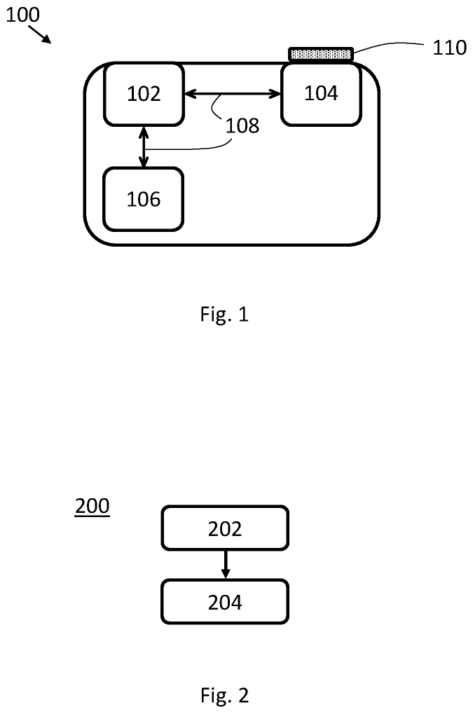

FIG. 1 shows a client device 100 according to at least one embodiment. In the embodiment shown in FIG. 1, the client device 100 includes a processor 102, a transceiver 104 and a memory 106. The processor 102 is coupled to the transceiver 104 and the memory 106 by communication means 108 known in the art. The client device 100 further includes an antenna or antenna array 110 coupled to the transceiver 104, which means that the client device 100 is configured for wireless communications in a wireless communication system.

That the client device 100 is configured to perform certain actions that are understood to mean that the client device 100 includes suitable means, such as e.g. the processor 102 and the transceiver 104, configured to perform said actions.

According to at least one embodiment, the client device 100 is configured to be served by a serving PLMN 610 and further is configured to obtain a PLMN list including one or more visiting PLMNs 620a, 620b, . . . , 620n. The client device 100 is further configured to register at a visiting PLMN in the PLMN list upon determining that the serving PLMN 610 is in a disaster condition.

FIG. 2 shows a flow chart of a corresponding method 200 which is executed in a client device 100, such as the one shown in FIG. 1, configured to be served by a serving PLMN 610. The method 200 includes obtaining 202 a PLMN list including one or more visiting PLMNs 620a, 620b, . . . , 620n. The method 200 further includes registering 204 at a visiting PLMN in the PLMN list upon determining that the serving PLMN 610 is in a disaster condition.

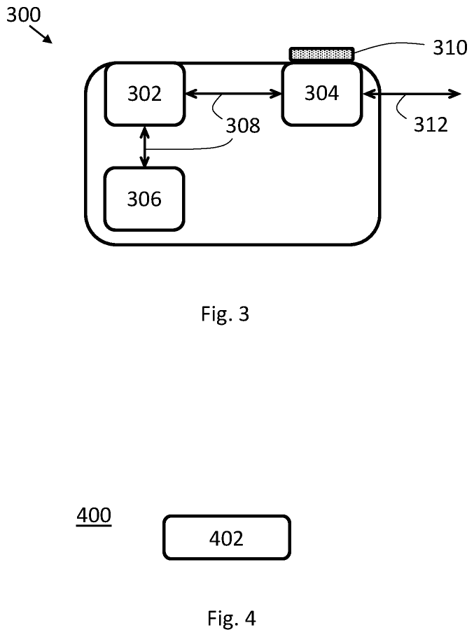

FIG. 3 shows a network node 300 according to at least one embodiment. In the embodiment shown in FIG. 3, the network node 300 includes a processor 302, a transceiver 304 and a memory 306. The processor 302 is coupled to the transceiver 304 and the memory 306 by communication means 308 known in the art. The network node 300 is configured for both wireless and wired communications in wireless and wired communication systems, respectively. The wireless communication capability is provided with an antenna or antenna array 310 coupled to the transceiver 304, while the wired communication capability is provided with a wired communication interface 312 coupled to the transceiver 304.

That the network node 300 is configured to perform certain actions is understood to mean that the network node 300 includes suitable means, such as e.g. the processor 302 and the transceiver 304, configured to perform said actions.

According to at least one embodiment, the network node 300 is configured to transmit a control message 510 to the client device 100. The control message 510 indicates a PLMN list including one or more visiting PLMNs 620a, 620b, . . . , 620n for registration by the client device 100 in response to a serving PLMN 610 for the client device 100 being in a disaster condition.

FIG. 4 shows a flow chart of a corresponding method 400 which is executed in a network node 300, such as the one shown in FIG. 3. The method 400 includes transmitting 402 a control message 510 to a client device 100. The control message 510 indicates a PLMN list including one or more visiting PLMNs 620a, 620b, . . . , 620n for registration by the client device 100 in response to a serving PLMN 610 for the client device 100 being in a disaster condition.

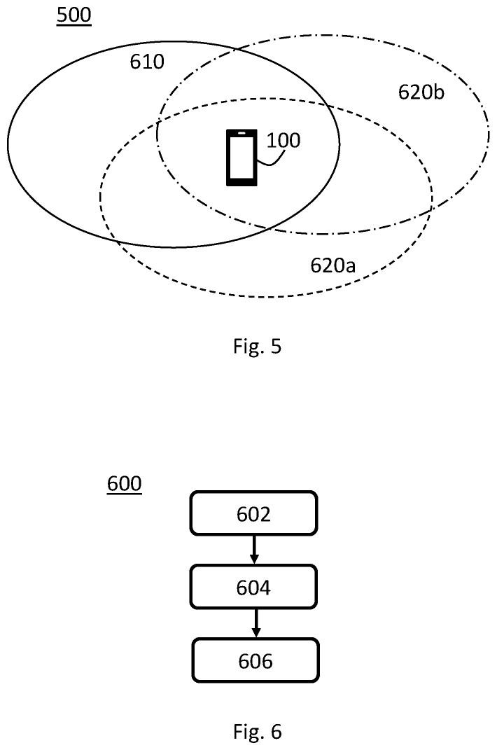

FIG. 5 shows a communication system 500 according to at least one embodiment. The communication system 500 includes the client device 100 and a number of PLMNs 610, 620a, 620b at least partly overlapping each other. The client device 100 is served by a serving PLMN 610. The serving PLMN 610 is a home PLMN or a visited PLMN. In the home country of the client device 100, the serving PLMN 610 is typically the home PLMN of the client device 100. In response to the client device 100 roaming in another country, the serving PLMN 610 is typically a visited PLMN.

A number of additional PLMNs cover at least partly the same area as the serving PLMN 610, herein referred to as one or more visiting PLMNs 620a, 620b, . . . , 620n. In the embodiment shown in FIG. 5, a first visiting PLMN 620a and a second visiting PLMN 620b covers the area where the client device 100 is located.

According to at least one embodiment, the client device 100 obtains a PLMN list that is used by the client device 100 in response to the serving PLMN 610 going into a disaster condition, i.e. in case a disaster happens that affects the serving PLMN 610. The PLMN list includes one or more visiting PLMNs 620a, 620b, . . . , 620n and upon determining that the serving PLMN 610 is in a disaster condition, the client device 100 registers at one of the visiting PLMNs in the PLMN list. Each visiting PLMN 620n is associated with a timer defining in response to the client device 100 attempting to register to the visiting PLMN 620n, e.g. defining a minimum wait time before registration. Furthermore, the one or more visiting PLMNs 620a, 620b, . . . , 620n is arranged in the PLMN list in a registration priority order. Thus, the client device 100 selects a visiting PLMN 620n from the PLMN list based on the order in which they are listed in the PLMN list and further register to the selected visiting PLMN 620n after a timer associated with the visiting PLMN 620n has expired, as will be further explained below with reference to FIG. 6.

With reference to FIG. 5, assume that the client device 100 obtains a PLMN list including the first visiting PLMN 620a and the second visiting PLMN 620b. Further assume that the serving PLMN 610 goes into a disaster condition and no longer provides any communication services to the client device 100, while the first visiting PLMN 620a and/or the second visiting PLMN 620b are operating normally, i.e. are not in a disaster condition. In this case, in response to the client device 100 determining that the serving PLMN 610 is in a disaster condition, the PLMN list enables the client device 100 to register at the first visiting PLMN 620a or the second visiting PLMN 620b, as will be further described below. Service interruption is thereby minimized for the client device 100 during a disaster.

FIG. 6 shows a flow chart of a method 600 according to at least one embodiment. The method 600 is performed by the client device 100 in response to being served by the serving PLMN 610.

In step 602, the client device 100 obtains a PLMN list including one or more visiting PLMNs 620a, 620b, . . . , 620n. Obtaining the PLMN list includes the client device 100 receiving a first control message 510 from a network node 300, where the first control message 510 indicates the PLMN list. The network node 300 is associated with the serving PLMN 610 which is understood to mean that the network node 300 is part of the serving PLMN 610, e.g. a function of a core network in the serving PLMN 610. The PLMN list is explicitly indicated in the control message 510, e.g. comprised in the control message 510 as a new or updated information element (IE). In embodiments, the first control message 510 is part of a non-access stratum (NAS) protocol. The first control message 510 is e.g. be any of: a configuration update command message, a registration accept message, a registration reject message, a service accept message, a service reject message, and a deregistration request message.

Obtaining the PLMN list further includes the client device 100 obtaining the PLMN list from at least one of a subscriber identity module (SIM) configuration of the client device 100 and a mobile equipment (ME) configuration of the client device 100. The PLMN list is e.g. pre-configured in the SIM and/or stored in the ME.

The obtained PLMN list includes an identity of each visiting PLMN 620n in the PLMN list. The identity of the visiting PLMN 620n enables the client device 100 to detect and register with the visiting PLMN 620n. The PLMN list further includes one or more timers T1, T2, . . . , Tn, where each timer Tn is associated with a visiting PLMN 620n in the PLMN list and defines a start register time instance at the visiting PLMN 620n and/or re-registration time instance at the serving PLMN 610. The timer Tn defines a minimum wait time to start registration and/or re-registration, i.e. a minimum time the client device 100 waits before the client device 100 attempts to register at the visiting PLMN 620n or re-register at the previously serving PLMN 610. In this way, the time instance at which the client device 100 registers and/or re-registers is controlled per visiting PLMN 620n. However, a single timer for all the one or more visiting PLMNs 620a, 620b, . . . , 620n in the PLMN list is also used without deviating from the scope embodiments described herein. Thus, the client device 100 uses in embodiments the same minimum wait time for registration to all visiting PLMNs and/or re-registration to the previously serving PLMN 610.

The value of the timer Tn is based on characteristics of the client device 100 and/or user, e.g. based on priority of the subscriber. For example, the client device of a high priority subscriber obtains a PLMN list where the timer Tn per visiting PLMN 620n has a lower value than for a client device of a normal or low priority subscriber. In this way, the client device of the high priority subscriber attempts to register earlier to the visiting PLMN 620n than the client device of the normal or low priority subscriber.

In embodiments, the one or more visiting PLMNs 620a, 620b, . . . , 620n in the PLMN list are arranged in a registration priority order for the client device 100. Each visiting PLMN 620n in the PLMN list is hence each be associated with a registration priority and e.g. is listed with the visiting PLMN 620n with the highest registration priority first in the PLMN list. In response to the client device 100 determining to register with a visiting PLMN 620n from the PLMN list, the client device 100 selects a visiting PLMN 620n from the PLMN list based on the registration priority order and e.g. first attempt to register with the visiting PLMN listed first in the PLMN list.

In step 604, the client device 100 determines that the serving PLMN 610 is in a disaster condition. The client device 100 determines that the serving PLMN 610 is in a disaster condition based on an indication from the serving PLMN 610 or another PLMN. In embodiments, determining that the serving PLMN 610 is in a disaster condition includes the client device 100 receiving a second control message 520 from a network node 300′, where the second control message 520 indicates that the serving PLMN 610 is in the disaster condition. The network node 300′ transmitting the second control message 520 is the same or a different network node than the network node 300 transmitting the first control message 510. The network node 300′ is e.g. a base station of a radio access network (RAN) or a function of a core network in the serving PLMN 610 or another PLMN.

The second control message 520 is e.g. a system information block (SIB) broadcasted by the network node 300′. In response to the serving PLMN 610 not being responsive, the client device 100 reads a SIB broadcasted from another PLMN and from there obtain an indication that the serving PLMN 610 is in a disaster condition.

Upon determining in step 604 that the serving PLMN 610 is in a disaster condition, the client device 100 register at a visiting PLMN 620n in the PLMN list in step 606. Step 606 includes the client device 100 camping on and sending a registration request to the visiting PLMN 620n selected from the PLMN list.

Before attempting to register at the visiting PLMN 620n in the PLMN list, the client device 100 has performed conventional PLMN selection unsuccessfully. The client device 100 has e.g. scanned for available PLMNs and only found forbidden PLMNs or found non-forbidden PLMNs but not been able to register with these PLMNs. The client device 100 then performs step 606 and register with a visiting PLMN in the PLMN list.

To indicate that the registration is associated with a disaster condition, the client device 100 indicates this to the visiting PLMN 620n in the registration request. Thereby, allowing the visiting PLMN 620n to provide special treatment to the client device 100. For example, the visiting PLMN 620n dilutes the authentication requirements as the client device 100 is seeking only temporary service from the visiting PLMN 620n. Step 606 in at least one embodiment includes the client device 100 transmitting a registration request message to the visiting PLMN 620n, where the registration request message indicates a registration request for the client device 100 in response to a previously serving PLMN 610 for the client device 100 being in the disaster condition.

The client device 100 selects the visited PLMN 620n from the PLMN list automatically or the visited PLMN 620n is selected manually by a user of the client device 100. For example, the client device 100 is operating in an automatic mode in which the client device 100 selects a PLMN automatically or in a manual mode in which a user is responsible for selecting a PLMN from a list of PLMNs presented to the user.

In response to the client device 100 operating in the automatic mode, the client device 100 automatically selects a visiting PLMN 620n in the PLMN list upon determining that the serving PLMN 610 is in a disaster condition. The selection is based on the PLMN list and a PLMN selection procedure while in disaster condition. The PLMN selection procedure defines e.g. that the visiting PLMNs should be selected from the PLMN list in the order in which they are listed in the PLMN list. Thus, the client device 100 selects the first visiting PLMN in the PLMN list and attempt to register to that visiting PLMN. In response to the registration not being successful, the client device 100 selects and attempt to register to the next visiting PLMN in the PLMN list.

In response to the PLMN list including a timer Tn associated with the selected visiting PLMN 620n which defines a start register time instance, the client device 100 starts the timer Tn associated with the visiting PLMN 620n upon camping at the visiting PLMN 620n and register at the visiting PLMN 620n in response to the timer Tn associated with the visiting PLMN 620n expiring. The client device 100 registers at the visiting PLMN 620n upon expiry of the timer or after expiry of the timer Tn, i.e. once the timer has expired the client device 100 registers at any time. The timer Tn hence defines a minimum wait time, i.e. a minimum time the client device 100 waits before the client device 100 attempts to register at the visiting PLMN 620n. In this way, registration of client devices with the visiting PLMN 620n due to a disaster condition in the serving PLMN 610 is controlled in time based on the PLMN list.

The timer Tn further defines a re-registration time instance at the serving PLMN 610 and is used once the disaster condition is over. In a similar way as for the registration, timer Tn defines a minimum wait time, i.e. a minimum time the client device 100 waits before the client device 100 attempts to re-register at the serving PLMN 610. Upon determining that the serving PLMN 610 is no longer in the disaster condition, the client device 100 re-registers with the serving PLMN 610 after the minimum wait time based on the timer Tn. Once the client device 100 camps on the serving PLMN 610, the client device 100 waits for the timer Tn to perform a registration update procedure towards the serving PLMN 610. This is to make sure that the serving PLMN 610 will not get congested in response to all its client devices attempting to come back after a disaster condition.

In response to the client device 100 operating in the manual mode, the client device 100 provides an output to a user of the client device 100. The output indicates that the one or more visiting PLMNs 620a, 620b, . . . , 620n in the PLMN list is selected for roaming in response to the serving PLMN 610 being in the disaster condition. Thus, in response to the serving PLMN 610 of the client device 100 being in the disaster condition, and the user of the client device 100 initiates a manual PLMN selection, the output according to at least one embodiment is presented to the user. The user is thereby provided with an indication that the one or more visiting PLMNs 620a, 620b, . . . , 620n supports disaster roaming and is safely select by the user even in response to the visiting PLMNs being forbidden PLMNs during normal condition.

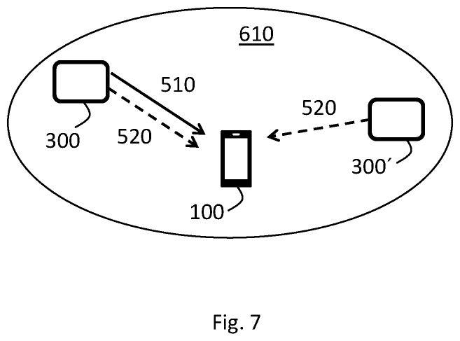

FIG. 7 shows signaling from the network node 300 according to at least one embodiment where the network node 300 provides a PLMN list to the client device 100. The network node 300 is e.g. an access and mobility management function (AMF) of a core network in the serving PLMN 610.

With reference to FIG. 7, the network node 300 transmit a control message 510 to the client device 100. The control message 510 indicates a PLMN list including one or more visiting PLMNs 620a, 620b, . . . , 620n for registration by the client device 100 in response to the serving PLMN 610 for the client device 100 being in a disaster condition. The control message 510 is part of a NAS protocol. The control message 510 is e.g. any of: a configuration update command message, a registration accept message, a registration reject message, a service accept message, a service reject message, and a deregistration request message. For example, the control message 510 is a new or updated information element (IE) in any of the above-mentioned messages.

As previously described, each visiting PLMN 620n in the PLMN list is associated with an identity and/or a timer Tn. With the value of timer Tn, the network node 300 controls in response to the client device 100 attempting to register with a visiting PLMN 620n in the PLMN list during a disaster condition. By providing different values of timer Tn to different client devices for the same visiting PLMN 620n, registration attempts with the visited PLMN 620n spread out in time such that the visited PLMN 620n is not overloaded in response to the serving PLMN 610 going into a disaster condition.

Furthermore, the one or more visiting PLMNs 620a, 620b, . . . , 620n in the PLMN list is arranged in a registration priority order for the client device 100. By providing different registration priority order to different client devices, client devices is distributed over the one or more visiting PLMNs 620a, 620b, . . . , 620n in the PLMN list such that a single visited PLMN 620n is not overloaded in response to the serving PLMN 610 going into a disaster condition. For example, in response to PLMN B and PLMN C supporting disaster roaming from PLMN A, PLMN A configures a first client device with the PLMN list (PLMN B, PLMN C) and a second client device with the PLMN list (PLMN C, PLMN B) so that the first client device will go to PLMN B and the second client device will go to PLMN C in response to a disaster condition occurring in PLMN A.

In response to the serving PLMN 610 entering a disaster condition, the network node 300 transmits a second control message 520 indicating that the serving PLMN 610 is in the disaster condition to the client device 100, as shown in FIG. 7. The second control message 520 in at least one embodiment instead be transmitted by another network node 300′ in the serving PLMN 610 or in another PLMN, i.e. the first control message 510 and the second control message 520 in at least embodiment is transmitted to the client device 100 from different network nodes.

The client device 100 herein, is denoted as a user device, a User Equipment (UE), a mobile station, an internet of things (IoT) device, a sensor device, a wireless terminal and/or a mobile terminal, is enabled to communicate wirelessly in a wireless communication system, sometimes also referred to as a cellular radio system. The UEs is further referred to as mobile telephones, cellular telephones, computer tablets or laptops with wireless capability. The UEs in this context is, for example, portable, pocket-storable, hand-held, computer-comprised, or vehicle-mounted mobile devices, enabled to communicate voice and/or data, via the radio access network, with another entity, such as another receiver or a server. The UE is a Station (STA), which is any device that contains an IEEE 802.11-conformant Media Access Control (MAC) and Physical Layer (PHY) interface to the Wireless Medium (WM). The UE is also configured for communication in 3GPP related LTE and LTE-Advanced, in WiMAX and its evolution, and in fifth generation wireless technologies, such as New Radio.

The network node 300, 300′ herein is denoted an access and mobility management function (AMF) of a core network as defined by the 3GPP standard. The AMF is a function configured for communication in 3GPP fifth generation wireless technologies, such as new radio (NR).

Furthermore, any method according to at least one embodiment is implemented in a computer program, having code means, which in response to being run by processing means causes the processing means to execute the steps of the method. The computer program is included in a computer readable medium of a computer program product. The computer readable medium includes essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the client device 100 and the network node 300 includes the communication capabilities in the form of e.g., functions, means, units, elements, etc., for performing the solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the solution.

Especially, the processor(s) of the client device 100 and the network node 300 includes, e.g., one or more instances of a Central Processing Unit (CPU), a processing unit, a processing circuit, a processor, an Application Specific Integrated Circuit (ASIC), a microprocessor, or other processing logic that interprets and executes instructions. The expression “processor” thus represents a processing circuitry including a plurality of processing circuits, such as, e.g., any, some or all of the ones mentioned above. The processing circuitry further performs data processing functions for inputting, outputting, and processing of data including data buffering and device control functions, such as call processing control, user interface control, or the like.

Finally, it should be understood that embodiment described herein are not limited as described above, but also relates to and incorporates all embodiments within the scope of the appended independent claims.

1. A client device for a communication system (500), the client device being configured to be served by a serving Public Land Mobile Network, PLMN, and further being configured to
obtain a PLMN list including one or more visiting PLMNs; and
register at a visiting PLMN in the PLMN list upon determining that the serving PLMN is in a disaster condition.

2. The client device according to claim 1, further configured to obtain the PLMN list by
receiving a first control message from a network node, wherein the first control message indicates the PLMN list.

3. The client device according to claim 2, wherein the first control message is part of a Non-Access Stratum, NAS, protocol.

4. The client device according to claim 3, wherein the first control message is any of: a configuration update command message, a registration accept message, a registration reject message, a service accept message, a service reject message, or a deregistration request message.

5. The client device according to claim 1, further configured to obtain the PLMN list by
obtaining the PLMN list from a Subscriber Identity Module, SIM, configuration of the client device.

6. The client device according to claim 1, further configured to obtain the PLMN list by
obtaining the PLMN list from a Mobile Equipment, ME, configuration of the client device.

7. The client device according to claim 1, wherein the PLMN list includes an identity of each visiting PLMN in the PLMN list.

8. The client device according to claim 1, wherein the PLMN list includes one or more timers (T1, T2, . . . , Tn), wherein each timer (Tn) is associated with a visiting PLMN in the PLMN list and defines a start register time instance at the visiting PLMN and/or a re-registration time instance at the serving PLMN.

9. The client device according to claim 8, further configured to
start a timer (Tn) associated with a visiting PLMN upon camping at the visiting PLMN; and
register at the visiting PLMN in response to the timer (Tn) associated with the visiting PLMN expiring.

10. The client device according to claim 1, wherein the one or more visiting PLMNs in the PLMN list are arranged in a registration priority order for the client device.

11. The client device according to claim 1, further configured to determine that the serving PLMN is in the disaster condition by
receiving a second control message from a network node (300″), wherein the second control message indicates that the serving PLMN is in the disaster condition.

12. The client device according to claim 1, further configured to
provide an output to a user of the client device, wherein the output indicates that the one or more visiting PLMNs in the PLMN list is selected for roaming in response to the serving PLMN being in the disaster condition.

13. The client device according to claim 1, further configured to register at the visiting PLMN in the PLMN list by
transmitting a registration request message to the visiting PLMN, wherein the registration request message indicates a registration request for the client device in response to a previously serving PLMN for the client device being in the disaster condition.

14. A network node for a communication system, the network node being configured to
transmit a control message to a client device, wherein the control message indicates a PLMN list including one or more visiting PLMNs for registration by the client device in response to a serving PLMN for the client device being in a disaster condition.

15. The network node according to claim 14, wherein the network node is an Access and Mobility management Function, AMF, of a core network.

16. The network node according to claim 14, wherein the control message is part of a NAS protocol.

17. The network node according to claim 16, wherein the control message is any of: a configuration update command message, a registration accept message, a registration reject message, a service accept message, a service reject message, or a deregistration request message.

18. A method for a client device being configured to be served by a serving PLMN (610), the method comprising:
obtaining a PLMN list including one or more visiting PLMNs; and
registering at a visiting PLMN in the PLMN list upon determining that the serving PLMN is in a disaster condition.

19. A method for a network node, further comprising:
transmitting a control message to a client device, wherein the control message indicates a PLMN list including one or more visiting PLMNs for registration by the client device in response to a serving PLMN for the client device being in a disaster condition.
